(19) United States
(12) Patent Application Publication
(10) Pub. No.: US 2009/0136805 A1
(43) Pub. Date: May 28, 2009

(54) FUEL CELL

(75) Inventors: Hiromichi Sato, Hadano-shi (JP); Seiji Sano, Gotemba-shi (JP); Takashi Kajiwara, Gotemba-shi (JP); Fumihiko Inui, Toyota-shi (JP); Yoshifumi Ota, Susono-shi (JP); Sho Usami, Susono-shi (JP); Katsumi Sato, Aichi-ken (JP); Norihiko Nakamura, Mishima-shi (JP); Tsuguhiro Fujita, Toyota-shi (JP); Takeshi Nagasawa, Okazaki-shi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: TOYOTA JIDOSHA KABUSHIKI KAISHA, Toyota-shi (JP)

(21) Appl. No.: 11/944,536

(22) Filed: Nov. 23, 2007

(51) Int. Cl. H01M 8/02

(52) U.S. Cl. 429/26

(57) ABSTRACT

A fuel cell includes a porous element, a first electrode, and a separator. The porous element is an element as a channel through which a reaction gas passes into the interior, the porous element having a first surface and a second surface. The first electrode is disposed on the first surface side of the porous element. The separator in contact with the second surface of the porous element is includes a first plate and a second plate, the first plate having a contact part in contact with the second surface, the second plate facing the first plate. A cooling medium channel is formed between the first plate and the second plate. The first plate has first dimples that are indented on a side of the first porous element and protrude on a side of the cooling medium channel.

### CROSS REFERENCE TO RELATED APPLICATIONS

This application relates to Japanese Patent Applications No. 2005-142837, filed on May 16, 2005 and No. 2005-296330, filed on Oct. 11, 2005, the entire disclosure of which is incorporated by reference.

### BACKGROUND

1. Technical Field

The present invention relates to a fuel cell, and in particular to the structure for distributing cooling medium.

2. Description of the Related Art

In fuel cells such as solid polymer fuel cells, hydrogen-containing fuel gas and oxygen-containing oxidation gas are supplied to two electrodes (oxygen electrode and fuel electrode) on either side of an electrolytic membrane to bring about an electrochemical reaction, directly converting the chemical energy of the substances to electrical energy. The primary structure which has been developed for such fuel cells is a stacked structure where generally flat membrane electrode assemblies (MEA) and separators are stacked and fastened in the stacked direction.

Known examples of fuel cell separators include those with a triple-layered structure consisting of an anode side plate, a cathode side plate, and an intermediary plate sandwiched between those two plates. In separators with this three-layered structure, manifolds for the supply and exhaust of the cooling medium that passes through the separators are provided in two opposite corners of the quadrangular separators. The intermediary plate is provided with a cooling medium channel communicating at both ends with the supply manifold and exhaust manifold.

There is a need to lower the heat capacity of fuel cells in order to improve the fuel cell start-up performance at low temperatures.

### SUMMARY

An object of the invention is to address at least one of the above problems, such as lowering the fuel cell heat capacity.

A first aspect of the present invention provides a fuel cell. The fuel cell pertaining to the first aspect comprises a porous element, a first electrode and a separator. The porous element is an element as a channel through which a reaction gas passes into the interior, the porous element having a first surface and a second surface. The first electrode is disposed on the first surface side of the porous element. The separator is in contact with the second surface of the porous element, the separator including a first plate and a second plate, the first plate having a contact part in contact with the second surface, the second plate facing the first plate. A cooling medium channel is formed between the first plate and the second plate. The first plate has first dimples that are indented on a side of the first porous element and protrude on a side of the cooling medium channel.

According to the fuel cell of the first aspect, the cooling medium is distributed by first dimples, allowing the volume of the separator to be reduced while preserving the cooling medium distribution performance. As a result, the fuel cell heat capacity can be reduced.

In the fuel cell pertaining to the first aspect, the first dimples of the first plate may be in contact with the second plate. In this case, the conduction between the first plate and second plate may be ensured.

In the fuel cell pertaining to the first aspect, the first electrode may be an anode. In this case, water is retained in the first dimples, preventing the anode side of the fuel cell from drying out.

In the fuel cell pertaining to the first aspect, the first electrode may be a cathode. In this case, water produced by the cathode is retained in the first dimples, further preventing the fuel cell from drying out.

In the fuel cell pertaining to the first aspect, the second plate may have second dimples that are indented on a side opposite the cooling medium channel and protrude on a side of the cooling medium channel. In this case, the cooling medium is distributed by the second dimples, allowing the volume of the separator to be reduced while preserving the cooling medium distribution performance.

In the fuel cell pertaining to the first aspect, the second dimples of the second plate may be in contact with the first plate, In this case, conductivity between the first plate and second plate may be ensured.

In the fuel cell pertaining to the first aspect, the second plate may face the second electrode on a side opposite the first plate.

In the fuel cell pertaining to the first aspect, the first electrode may be a cathode, the second electrode may be an anode, and a total indented volume of the first dimples may be lower than a total indented volume of the second dimples. In this case, the indentation volume of the first dimples where the water produced by the cathode is retained may be reduced to improve the drainage of the produced water.

In the fuel cell pertaining to the first aspect, the first electrode may be a cathode, the second electrode may be an anode, and a total indented volume of the second dimples may lower than a total indented volume of the first dimples. In this case, the indentation volume of the first dimples where the water produced by the cathode is retained may be expanded to prevent the fuel cell from drying out.

In the fuel cell pertaining to the first aspect, at least some of the first dimples may be generally staggered, as viewed from a normal line direction of the first plate. In this case, the diffusion of the cooling medium may be improved and the cooling performance may be improved.

In the fuel cell pertaining to the first aspect, at least some of the first dimples may be disposed in a generally checkerboard pattern, as viewed from a normal line direction of the first plate. In this case, cooling medium pressure loss may be controlled.

In the fuel cell pertaining to the first aspect, at least some of the first dimples may have a generally circular shape, as viewed from a normal line direction of the first plate. In this case, stress in the normal line direction may be readily diffused, thereby improving the homogeneity of the surface pressure on the first electrode.

In the fuel cell pertaining to the first aspect, at least some of the first dimples may have a generally polygonal shape, may have a shape with a short side and a long side and may have profiles with a different curvature, as viewed from a normal line direction of the first plate. In these cases, the first dimples may be prevented from being deformed by stress in the normal line direction.

In the fuel cell pertaining to the first aspect, the first plate may have undergone hydrophilicization. In this case, fuel cell water drainage may be improved.

The present invention may be realized in various aspects, for example, a separator using above-mentioned fuel cell. The invention may also be realized as a fuel cell system including a fuel cell pertaining to the above-mentioned aspects and a vehicle quipped with a fuel cell system including a fuel cell pertaining to the above-mentioned aspects.

The above and other objects, characterizing features, aspects and advantages of the invention will be clear from the description of preferred embodiments presented below along with the attached Figures.

### BRIEF DESCRIPTION OF THE DRAWINGS

FIG. 1 illustrates the structure of the fuel cell stack in the first embodiment;

FIG. 2 illustrates the structure of the layer units 200 of the fuel cell stack;

FIGS. 3A-C are elevations of the anode plate, cathode plate, and intermediary plate in the first embodiment;

FIGS. 4A-E illustrate the structure of the distributor in the first embodiment;

FIGS. 5A-C illustrate the flow of the reaction gas and cooling medium in the fuel cell stack 100 in the first embodiment;

FIGS. 6A-E illustrate the structure of the distributor in Variation 1 of the first embodiment;

FIG. 7 illustrates the structure of the distributor in the Variation 2 of the first embodiment;

FIGS. 8A-D illustrate the structure of the distributor in the second embodiment;

FIG. 9 illustrates the structure of the distributor in a variation of second embodiment;

FIG. 10 illustrates the structure of the separator in the third embodiment;

FIGS. 11A-C illustrate the structure of the separator in the third embodiment;

FIGS. 12A-C illustrate the structure of the separator in Variation 1 of the third embodiment;

FIGS. 13A-C illustrate the structure of an example of the separator in Variation 2 of the third embodiment;

FIGS. 14A-C illustrate the structure of another example of the separator in Variation 2 of the third embodiment;

FIGS. 15A-C illustrate the structure of the separator in Variation 3 of the third embodiment;

FIGS. 16A-C illustrate the structure of the separator in Variation 4 of the third embodiment;

FIGS. 17A-C illustrate the structure of the separator in Variation 5 of the third embodiment.

### DETAILED DESCRIPTION OF THE PREFERRED EMBODIMENTS

The invention will be illustrated in the following embodiments with reference to the attached drawings.

### A. First Embodiment

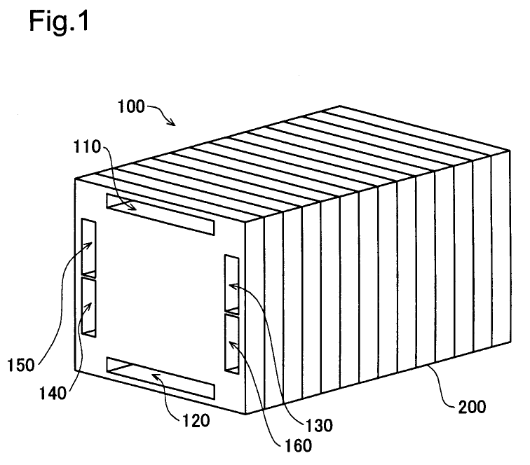

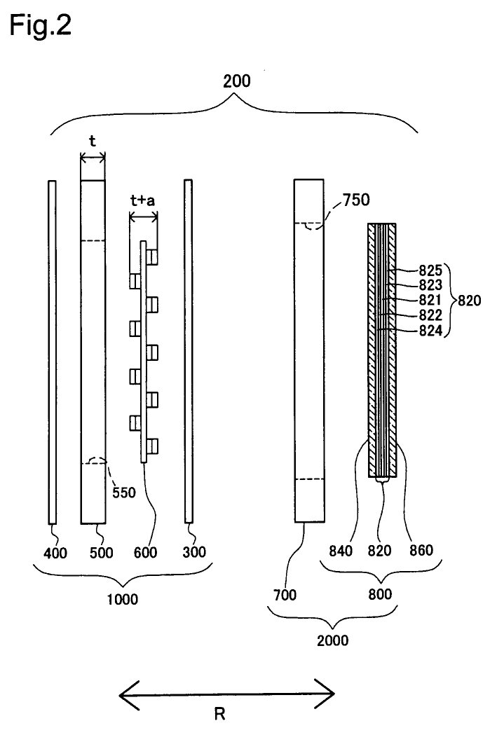

The schematic structure of a fuel cell stack including a separator in a first embodiment of the invention will be illustrated with reference to FIGS. 1 and 2. FIG. 1 illustrates the structure of the fuel cell stack in the first embodiment. FIG. 2 illustrates the structure of the layer units 200 of the fuel cell stack.

The fuel cell stack 100 is constructed by stacking a plurality of layer units 200. The fuel cell stack 100 is equipped with an oxidation gas supply manifold 110, oxidation gas exhaust manifold 120, fuel gas supply manifold 130, fuel gas exhaust manifold 140, cooling medium supply manifold 150, and cooling medium exhaust manifold 160. Air is generally used as the oxidation gas, and hydrogen is generally used as the fuel gas. The oxidation gas and fuel gas together are referred to as the reaction gas. Water, non-freezing water such as ethylene glycol, air, or the like may be used as the cooling medium.

As illustrated in FIG. 2, the layer unit 200 includes a separator 1000 and a seal-integrated type power generation section 2000.

The separator 1000 is equipped with an anode plate 300, cathode plate 400, intermediary plate 500, and distributor 600. The approximate middle portion of the intermediary plate 500 is provided with a through hole 550 that passes through the intermediate plate 500 in the thicknesswise direction as illustrated by the dashed line. The distributor 600 is disposed in the through hole 550 of the intermediary plate 500. The anode plate 300 and cathode plate 400 are joined to either side of the intermediary plate 500 to sandwich the intermediary plate 500. The three plates can be joined, for example by thermal bonding, brazing or welding. The direction indicated by the arrow R in FIG. 2 is the direction in which the layer units 200 of the fuel cell stack 100 are stacked, and is the direction in which the three plates 300, 400, and 500 of the separator 1000 are stacked. The direction indicated by the arrow R is referred to below as the stacking direction.

The seal-integrated type power generation section 2000 is equipped with a seal member 700 and a power generation section 800. The seal member 700 is formed of a gas-impermeable, elastic, heat-resistant material such as silicon rubber. A hole 750 in which the power generation section 800 is disposed is provided in the middle of the seal member 700 as indicated by the dashed line. The power generation section 800 is provided with a membrane electrode assembly 820, anode side porous element 840, and cathode side porous element 860. The membrane electrode assembly 820 is equipped with an electrolyte layer 821, anode 822 and cathode 823 as electrodes, anode side diffusion layer 824, and cathode side diffusion layer 825. The anode 822 and anode side diffusion layer 824 are disposed, in that order, on one side of the electrolyte layer 821. The cathode 823 and cathode side diffusion layer 825 are disposed, in that order, on the other side of the electrolyte layer 821. The electrolyte layer 821 is an ion exchange film with good conductivity in a moist state, formed of a fluororesin such as Nafion (registered trademark, DuPont). The anode 822 and cathode 823 are formed with a catalytic material such as platinum or an alloy including platinum and another metal. The anode diffusion layer 824 and cathode diffusion layer 825 are formed, for example, by means of a carbon cloth, carbon paper or carbon felt made of carbon fibers. The anode side porous element 840 and cathode side porous element 860 are formed of a gas-diffusion, conductive porous material such as a metal porous element. The anode side diffusion layer 824 and cathode side diffusion layer 825 are softer than the anode side porous element 840 and cathode side porous element 860. The anode side diffusion layer 824 and cathode side diffusion layer 825 may be left out.

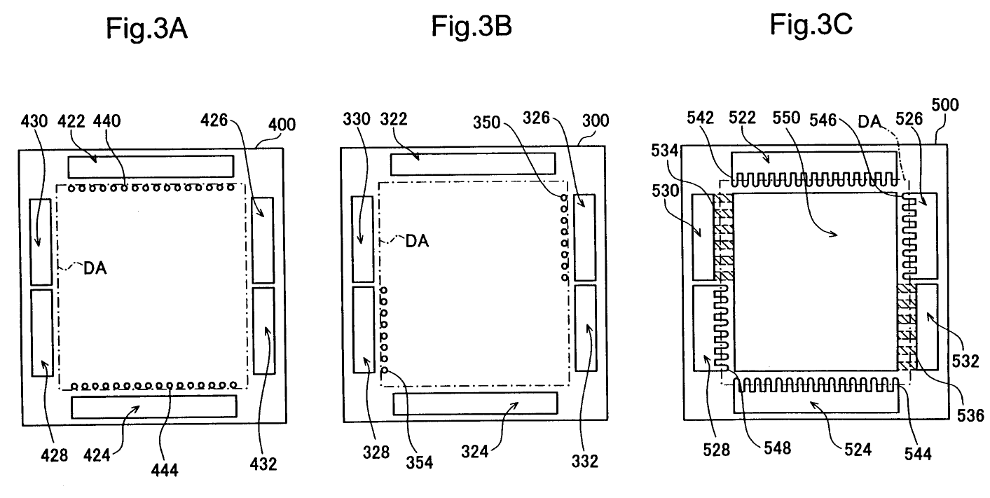

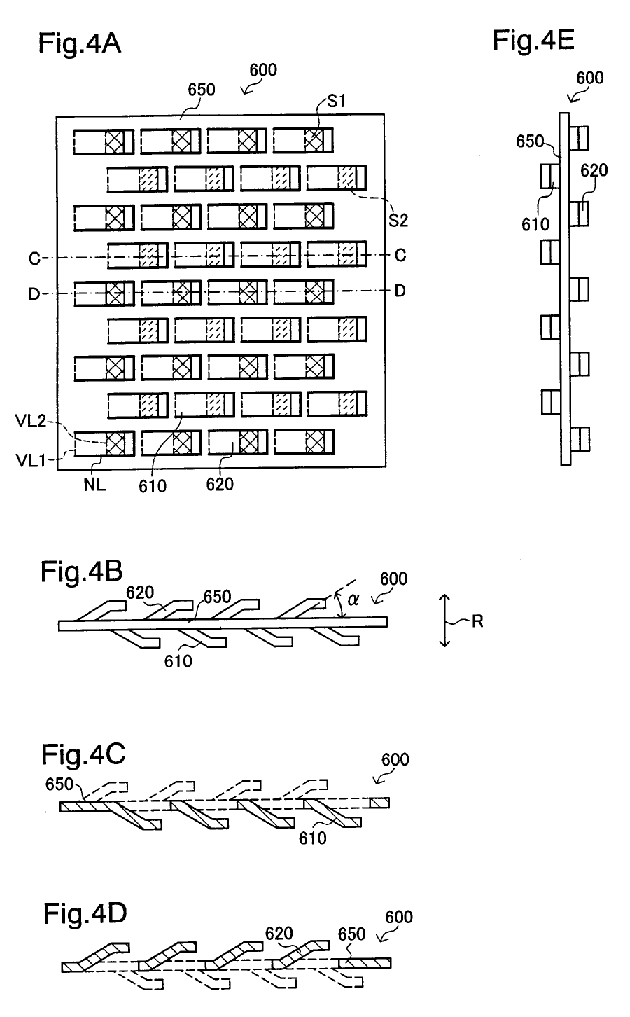

The structure of the separator 1000 will be further described with reference to FIGS. 3A-C and FIGS. 4A-E. FIGS. 3A-C are elevations of the anode plate, cathode plate, and intermediary plate in this embodiment. FIGS. 4A-E illustrate the structure of the distributor in the first embodiment. FIG. 4A is an elevation of the distributor member 600. FIG. 4B is a bottom view of the distributor member 600. FIG. 4E is a side view of the distributor member 600. FIGS. 4C and 4D are cross sections of C-C and D-D, respectively, in FIG. 4A. In FIGS. 3A-C, the area DA indicated by the dashed line in the middle of the plates 400, 300, and 500 is the area which overlaps the above power generation section 800 as seen from the stacking direction R when the fuel cell stack 100 is formed (referred to below as power generation area DA).

The cathode plate 400 is formed with stainless steel. The cathode plate 400 is equipped with six manifold-forming portions 422 through 432, a plurality of oxidation gas supply ports 440, and a plurality of oxidation gas exhaust ports 444. The manifold-forming portions 422 through 432 are through holes forming the various manifolds described above when the fuel cell stack 100 is formed, and are provided outside the power generation area DA. The plurality of oxidation gas supply ports 440 are disposed side-by-side at the top end of the power generation area DA. The plurality of oxidation gas exhaust ports 444 are disposed side-by-side at the bottom end of the power generation area DA.

The anode plate 300 is formed with stainless steel in the same manner as the cathode plate 400, and is equipped with six manifold-forming portions 322 through 332, a plurality of fuel gas supply ports 350, and a plurality of fuel gas exhaust ports 354. The manifold-forming portions 322 through 332 are through holes forming the various manifolds described above when the fuel cell stack 100 is formed, and are provided outside the power generation area DA in the same manner as the cathode plate 400. The plurality of fuel gas supply ports 350 are disposed side-by-side at the right end of the power generation area DA. The plurality of fuel gas exhaust ports 354 are disposed side-by-side at the left end of the power generation area DA.

The intermediary plate 500 is formed with a heat-resistant resin, for example. When a heat-resistant resin is used, the temperature at which the three plates are joined (by heat bonding, for example) will be lower than when metal materials are used, resulting in the advantage of being able to control thermal deformation of the separator 1000. The intermediary plate 500 has, in addition to the through hole 550 described above, six manifold-forming portions 522 through 532, supply channel-forming portions 542/546 and exhaust channel-forming portions 544, 548 for the supply and exhaust of reaction gas (oxidation gas or fuel gas), a plurality of cooling medium supply channels 534, and a plurality of cooling medium exhaust channels 356.

The through hole 550 is formed over the most part of the power generation area DA. A space through which the cooling medium flows is formed by the through hole 550 between the anode plate 300 and cathode plate 400 when the three plates are joined. The through hole 550 is therefore referred to below as the cooling medium flow room 550.

The manifold-forming portions 522 through 532 are through holes forming the various manifolds described above when the fuel cell stack 100 is formed, and are provided outside the power generation area DA in the same manner as the cathode plate 400 and anode plate 300.

The cooling medium supply channel 534 communicates with the cooling medium flow room 550 and the cooling medium supply manifold-forming portion 530. The cooling medium exhaust channel 536 communicates with the cooling medium flow room 550 and the cooling medium exhaust manifold-forming portion 532. The channels 534 and 536 are formed through, in the planar direction, inside of the intermediary plate 500.

The oxidation gas and fuel gas supply channel-forming portions 542 and 546 and the exhaust channel-forming portions 544 and 548 communicate at one end with the corresponding manifold-forming portions 522 through 532, respectively. The other ends of the channel-forming portions 542 through 548 communicate with the corresponding gas supply/exhaust ports 350, 354, 440, and 444, respectively, when the three plates are joined.

The distributor 600 is a separate member from the three plates 300, 400, and 500, as shown in FIG. 2, and is equipped with a plurality of first plate-shaped members 610 and a plurality of second plate-shaped members 620, as shown in FIGS. 4A-E. The distributor 600 is produced by plastic forming (such as press forming) to a plate-like material (referred to below as base plate) to form a substrate 650, first plate-shaped member 610 and second plate-shaped member 620. The base plate is thinner than the intermediary plate 500. In this embodiment, dense, non-porous stainless steel is used.

The first plate-shaped members 610 and second plate-shaped members 620 are formed, during press forming, by cutting the base plate along the U-shaped cutting lines NL as illustrated for the second plate-shaped member 620 in the lower left of FIG. 4A, and bending the generally U-shaped parts at the two bending lines VL1 and VL2. The generally U-shaped parts bent at the bending line VL1 correspond to the first plate-shaped members 610 and the second plate-shaped members 620. The unprocessed parts other than the generally U-shaped parts correspond to the substrate 650. Specifically, these plate-shaped members 610 and 620 are bent at a certain angle α at the bending lines VL1, thereby extending at the certain angle α relative to the substrate 650. The certain angle α L is determined according to the stacking direction thickness of the distributor 600 that is to be formed, the magnitude of the necessary repulsion force (described below), and the like, but is preferably no more than 90° without producing a negative angle.

The first plate-shaped members 610 are bent at the bending line VL2 so that the end (distal end from the bending line VL2) is parallel to the substrate 650. The first plate-shaped members 610 are formed on the anode plate 300 side (lower side in FIG. 4B), as viewed from the substrate 650, when assembled with the three plates 300, 400, and 500 to form the separator 1000 (referred to below as assembly). The second plate-shaped members 620, on the other hand, are formed on the cathode plate 400 side (upper side in FIG. 4B), as viewed from the substrate 650.

The first plate-shaped members 610 and second plate-shaped members 620 are generally in the form of a plate spring, as illustrated in FIGS. 4A-E, and are thus elastically deformed in the stacking direction R during assembly. That is, when compressed in the vertical direction in FIG. 4B, repulsion force tending to bring about a return to the original shape is produced in the direction of arrow R in FIG. 4B.

The thickness (t+a) of the distributor 600 in the stacking direction is greater than the thickness of the intermediary plate 500. During assembly, the distributor 600 therefore comes into contact with the anode plate 300 and cathode plate 400 and is compressed in the stacking direction. During assembly, the contact between the distributor 600 and anode plate 300 and between the distributor 600 and cathode plate 400 is thus strengthened by the repulsion force against the compression described above. In FIG. 4A, the crosshatched portion S1 of the first plate-shaped members 610 indicates the portion in contact with the anode plate 300 during assembly. The portion S2 of the second plate-shaped members 620 that is hatched by the dashed line indicates the portion in contact with the cathode plate 400 during assembly.

As illustrated in FIG. 4A, a plurality of the first plate-shaped members 610 and second plate-shaped members 620 are formed. The plurality of the first plate-shaped members 610 and second plate-shaped members 620 are disposed in a regulate pattern over the entire distributor 600. In the examples illustrated in FIGS. 4A-E, the rows of the first plate-shaped members 610 (row C-C in FIG. 4A) and the rows of the second plate-shaped members 620 (row D-D in FIG. 4A) are alternately disposed vertically in FIG. 4A.

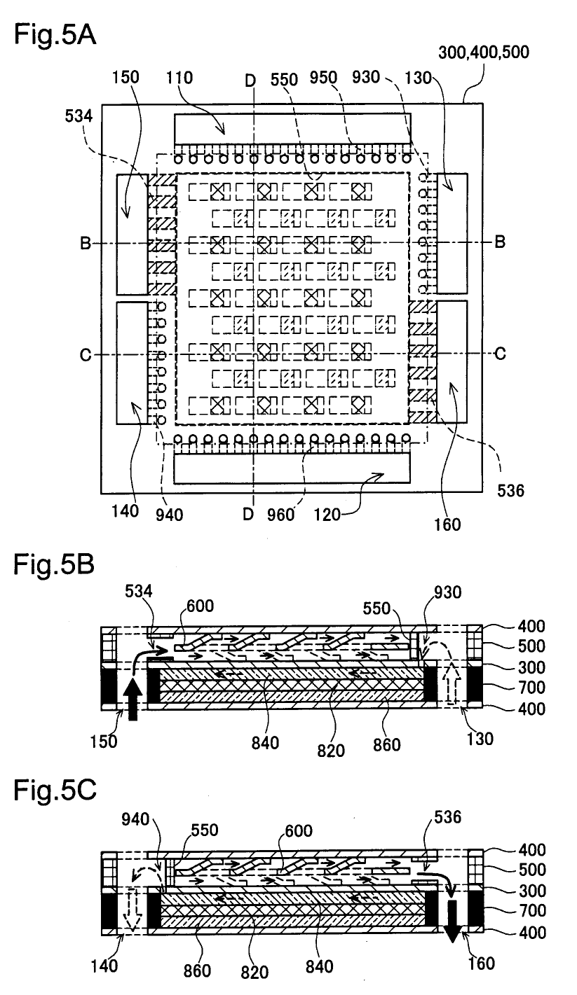

The flow of the reaction gas (oxidation gas and fuel gas) and the cooling medium in this embodiment will be described with reference to FIGS. 5A-C. FIGS. 5A-C illustrate the flow of the reaction gas and cooling medium in the fuel cell stack 100 in this embodiment. FIG. 5A is an elevation of the separator 1000. FIGS. 5B and 5C are cross sections of the fuel cell stack 100 corresponding to lines B-B and C-C, respectively, in FIG. 5A.

The flow of the fuel gas will be described as an example of the flow of reaction gas. The fuel gas is supplied from the fuel gas supply manifold 130 through the fuel gas supply channel 930 to the anode side porous element 840, as illustrated by the dashed line arrow in FIG. 5B. The fuel gas supply channel 930 is formed by the fuel gas supply channel-forming portion 546 of the intermediary plate 500 and the fuel gas supply port 350 of the anode plate 300 during assembly. Some of the fuel gas supplied to the anode side porous element 840 is used in the fuel cell reaction in the anode 822 while flowing in the anode side porous element 840. The fuel gas that has been used is discharged from the anode side porous element 840 through the fuel cell gas exhaust channel 940 to the fuel gas exhaust manifold 140. As may be understood from the description above, because no channels such as grooves are formed as the fuel gas channel in the separator of this embodiment, the anode side porous element 840 functions as the fuel gas channel linking the fuel gas supply channel 930 and the fuel cell gas exhaust channel 940. The fuel cell gas exhaust channel 940 is formed by the fuel gas exhaust channel-forming portion 548 of the intermediary plate 500 and the fuel gas exhaust port 354 of the anode plate 300 during assembly. In the cross section D-D in FIG. 5A, the oxidation gas supply channel 950 and the oxidation gas exhaust channel 960 are formed by the same structure as the fuel gas supply channel 930 and fuel cell gas exhaust channel 940 above. The oxidation gas is supplied from the oxidation gas supply manifold 110 through the oxidation gas supply channel 950 to the cathode side porous element 860. Some of the oxidation gas supplied to the cathode side porous element 860 is used in the fuel cell reaction in the cathode 823 while flowing in the cathode side porous element 860. The oxidation gas is discharged through the oxidation gas exhaust channel 960 to the oxidation gas exhaust manifold 120. As may be understood from the description above, because no channels such as grooves are formed as the oxidation gas channel in the separator of this embodiment, the cathode side porous element 860 functions as the oxidation gas supply channel 950 and the oxidation gas exhaust channel 960.

The cooling medium is supplied from the cooling medium supply manifold 150 through the cooling medium supply channel 534 of the intermediary plate 500 to the cooling medium flow room 550 described above as indicated by the solid line arrow in FIG. 5B. The cooling medium supplied to the cooling medium flow room 550 is diffused in the planar direction of the separator 1000 (direction perpendicular to the stacking direction R) by the distributor 600 described above. After flowing in the cooling medium flow room 550, the cooling medium is discharged through the cooling medium exhaust channel 536 of the intermediary plate 500 to the cooling medium exhaust manifold 160, as indicated by the solid line arrow in FIG. 5C. While flowing primarily through the cooling medium flow room 550, the cooling medium absorbs the thermal energy of the fuel cell stack 100 to cool the fuel cell stack 100.

In the separator of the first embodiment described above, the cooling medium is distributed by the distributor 600 disposed in the cooling medium flow room 550, allowing the fuel cell stack 100 to be efficiently cooled.

The first plate-shaped members 610 and second plate-shaped members 620 of the distributor 600 are in contact at one end with the anode plate 300 and cathode plate 400, as noted above, allowing the electrical conductivity of the separator 1000 to be preserved. The area of the distributor 600 in contact with the anode plate 300 and with the cathode plate 400 can be adjusted by means of the shape of the ends of the first plate-shaped members 610 and second plate-shaped members 620. That is, in conventional separators, the intermediary plate is punched to form the cooling medium channel, resulting in the problem of a narrow cooling medium channel when the contact surface area was increased, but in the separator 1000 of this embodiment, the contact area may be increased relatively freely while ensuring space for the cooling medium to flow through. It is thus possible to provide both cooling performance and conductivity.

In addition, the width of the distributor 600 in the stacking direction is greater than the width of the intermediary plate 500, ensuring that the distributor 600 comes into contact with the anode plate 300 and cathode plate 400 during assembly.

Furthermore, the distributor 600 is pushed against the anode plate 300 and cathode plate 400 by the repulsion force against the compression during assembly, thereby minimizing pressure resistance between the distributor 600 and anode plate 300 and between the distributor 600 and cathode plate 400, and increasing the electrical conductivity of the separator 1000.

The distributor 600 is also disposed so as to improve separator 1000 rigidity.

The distributor 600 is also produced by pressing a base plate, and may therefore be readily produced.

### Variations of First Embodiment

### Variation 1

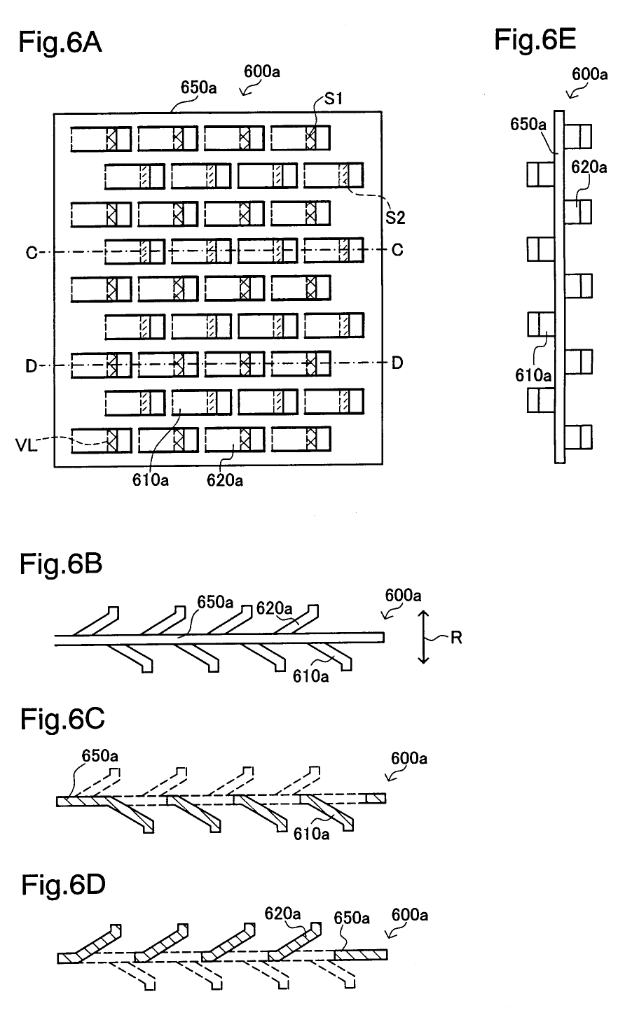

The separator 1000 in Variation 1 of the first embodiment will be described with reference to FIG. 6. FIGS. 6A-E illustrate the structure of the distributor in this variation. This variation and Variation 2 described below differ from the first embodiment in the shape of the first and second plate-shaped members of the distributor. The structure is otherwise similar to the first embodiment and will therefore not be further elaborated.

In the distributor 600a of this Variation, the ends of the first plate-shaped members 610a and second plate-shaped members 620a are bent perpendicular to the substrate 650a (parallel to the stacking direction R) at the folding lines VL shown in FIG. 6A. In other words, the cut sections cut from the base plate are in contact with the anode plate 300 and cathode plate 400 during assembly when the first plate-shaped members 610a and second plate-shaped members 620a are formed. Thus, during assembly, the first plate-shaped members 610a contacts with the anode plate 300 and cathode plate 400 at a narrower area (S1 and S2 in FIG. 6A) than the distributor 600 in the first embodiment.

In the separator 1000 in this variation, the contact area between the first plate-shaped members 610a and the anode plate 300 is smaller. As a result, the contact pressure between the first plate-shaped members 610a and anode plate 300 is greater. The ends of the first plate-shaped members 610a may therefore more effectively break through the oxidized film formed on the surface of the anode plate 300 and further reduce contact resistance. The same effects hold true for contact between the second plate-shaped members 620a and cathode plate 400.

### Variation 2

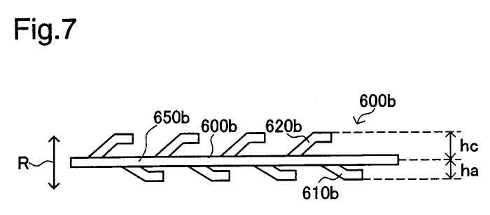

The separator 1000 in Variation 2 of the first embodiment will be described with reference to FIG. 7. FIG. 7 illustrates the structure of the distributor in this variation.

The first plate-shaped members 610b and second plate-shaped members 620b in the distributor 600b in this variation have different shapes. Specifically, the distance hc from the end of the second plate-shaped members 620b to the substrate 650 is greater than the distance ha from the end of the first plate-shaped members 610b to the substrate 650. As a result, during assembly, the gap between the substrate 650 of the distributor 600 and the cathode plate 400 is greater than the gap between the substrate 650 of the distributor 600 and the anode plate 300.

In the separator 1000 of this variation, the amount of cooling medium flowing in the cooling medium flow room 550 is greater on the cathode plate 400 side of the substrate 650 than on the anode plate 300 side of the substrate 650.

### B. Second Embodiment

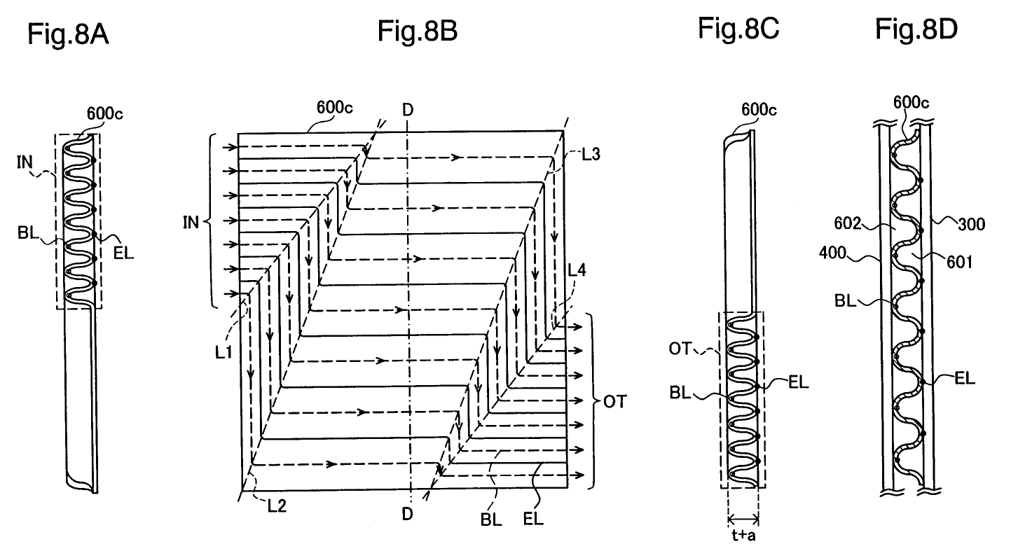

The separator 1000 in a second embodiment will be described with reference to FIGS. 8A-D. FIGS. 8A-D illustrate the structure of the distributor in the second embodiment. FIG. 8B is an elevation of the distributor 600c. FIG. 8A is a view of the left side of the distributor 600c (viewed from left side of FIG. 8B). FIG. 8C is a view of the right side of the distributor 600c (viewed from right side of FIG. 8B). FIG. 8D is a cross section of the distributor 600c (cross section D-D in FIG. 8B). The second embodiment is different from the first embodiment in that the distributor 600c illustrated in FIGS. 8A through 8D is used in the second embodiment instead of the distributor 600 in the first embodiment. The structure is otherwise similar to the first embodiment and will therefore not be further elaborated.

The distributor 600c is produced by pressing a plate member that is thinner than the intermediary plate 500. The distributor 600c is a conductive material, for example, a metal such as stainless steel or titanium, in the same manner as the distributor 600 in the first embodiment.

The portion IN indicated by the dashed line in the left view (FIG. 8A) is a portion in contact (referred to as inlet below) with the cooling medium supply channel 534 of the intermediary plate 500 during assembly. The portion OT indicated by the dashed line in the right view (FIG. 8C) is a portion adjacent (referred to below as outlet) to the cooling medium exhaust channel 536 of the intermediary plate 500 during assembly.

The distributor 600 has a continuous undulating shape with a cross section, as illustrated in FIG. 8D. A plurality of grooves forming the cooling medium channel during assembly are formed by this undulating shape on both sides of the distributor 600. The plurality of grooves extend from the inlet IN to the outlet OT while folded at the portions indicated by the dashed lines L1 through L4 midway, as illustrated in FIG. 8B. The solid lines EL in FIG. 8B indicate the edges where the plurality of grooves formed on one side of the distributor 600 are adjacent (corresponding points EL in FIGS. 8A, C, and D). The dashed lines BL in FIG. 8B indicate the floors of the plurality of grooves formed on one side of the distributor 600 (corresponding points BL in FIGS. 8A, C, and D). In the grooves formed on the other side of the distributor 600, the reverse side of the edges EL described above correspond to the floors of the grooves, and the reverse side of the above floors BL correspond to the edges.

During assembly, the distributor 600 c divides the cooling medium flow room 550 into a plurality of cooling medium channels. That is, as illustrated in FIG. 8D, a plurality of anode side cooling medium channels 601 are formed between the distributor 600 and the anode plate 400, and a plurality of cathode side cooling medium channels 602 are formed between the distributor 600 and the cathode plate 400. Part of the assembled anode plate 300 and cathode plate 400 are illustrated along with the distributor 600 in FIG. 8D, for a better understanding of the description.

The cooling medium flowing from the cooling medium supply channel 534 into the cooling medium flow room 550 flows from the inlet IN described above through the cooling medium channels 601 and 602 in the planar direction of the separator 1000, and is distributed throughout the cooling medium flow room 550 in its entirety. The distributed cooling medium is guided to the outlet OT described above, and is discharged from the cooling medium exhaust channel 536 to the cooling medium exhaust manifold 160.

The width of the distributor 600 in the stacking direction is greater than the thickness of the intermediary plate 500 (t+a). During assembly, the distributor 600c therefore comes into reliable contact with the plates 300 and 400 at the edges EL of the distributor 600c described above. For example, during assembly, the edge EL portions of the distributor 600c are squeezed, whereby the contact area may be ensured. Alternatively, the distributor 600c may be produced with a highly elastic material, and the repulsion force of the distributor 600c may strengthen the contact between the distributor 600c and the plates 300 and 400 in the same manner as in the first embodiment.

As illustrated above, the cooling medium channels are arranged by the separator 1000 of the second embodiment throughout the cooling medium flow room 550 in its entirety while ensuring contact between the distributor 600c and the plates 300 and 400. This allows both cooling performance and electrical conductivity to be provided in the same manner as the separator 1000 in the first embodiment.

### Variations of Second Embodiment

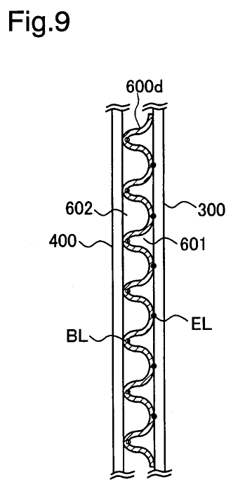

The separator 1000 in a Variation of the second embodiment will be described with reference to FIG. 9. FIG. 9 illustrates the structure of the distributor in this variation. FIG. 9 corresponds to cross section D-D in FIG. 8A.

The undulating shape of the cross section of the distributor 600d in this variation is different from distributor 600c in the second embodiment described above. The structure is otherwise similar to the first embodiment and will therefore not be further elaborated.

As illustrated in FIG. 9, the undulating shape of the cross section of the distributor 600d is distorted in this variation, so that the cross section area of the anode side cooling medium channels 601 are different from the cross section area of the cathode side cooling medium channels 602. Specifically, the cross section area of the cathode side cooling medium channels 602 formed on the cathode plate 400 side of the distributor 600d is greater than the cross section area of the anode side cooling medium channels 601 formed on the anode plate 300 side of the distributor 600d.

This will make the flow of cooling medium flowing through the cathode side cooling medium channels 602 greater than the flow of cooling medium flowing through the anode side cooling medium channels 601. As a result, the cathode side porous element 860, where more heat is produced, may be efficiently cooled in the same manner as in the first embodiment.

### C. Third Embodiment

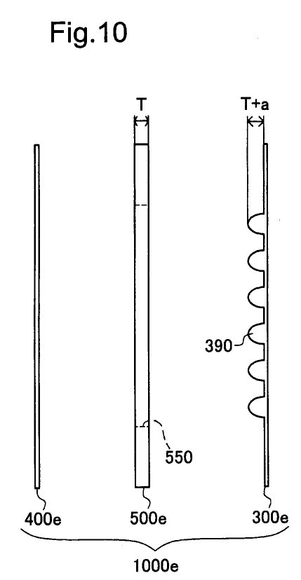

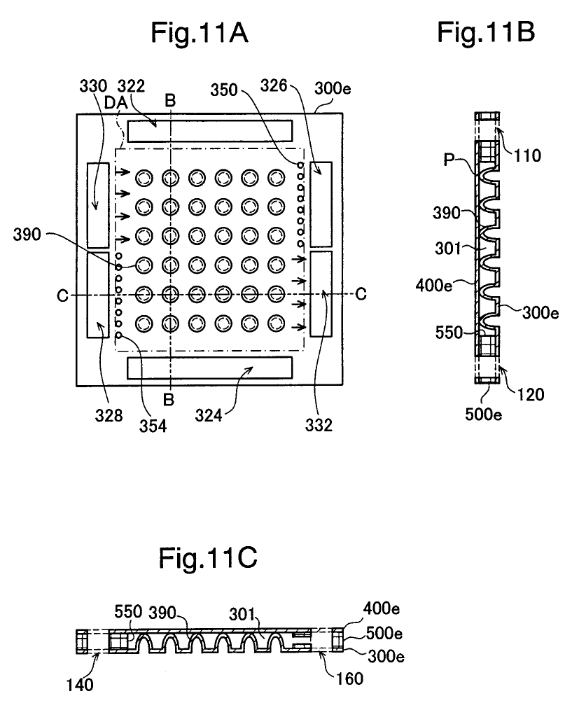

The separator in the third embodiment will be described with reference to FIGS. 10 and 11A-C. FIG. 10 illustrates the structure of the separator in the third embodiment. FIGS. 11A-C illustrate the structure of the separator in the third embodiment. FIG. 11A is an elevation of the anode plate 300e. FIGS. 11B and 11C are cross sections of the separator 1000e corresponding to line B-B and line C-C in FIG. 11A.

The separator 1000e in this embodiment is equipped with an anode plate 300e, cathode plate 400e, and intermediary plate 500e in the same manner as the first embodiment, but unlike the first embodiment does not have a separate distributor.

The cathode plate 400e and intermediary plate 500e have the same structure as the cathode plate 400 and intermediary plate 500 in the first embodiment, and therefore will not be further elaborated.

The anode plate 300e differs from the first embodiment by having a plurality of dimples 390 in generally the center, as illustrated in FIG. 11A. The structure of the anode plate 300e is otherwise similar to the anode plate 300 in the first embodiment which has been described with reference to FIG. 3B, and symbols in FIGS. 11A-C which are the same as in FIG. 3B will not be further elaborated.

The plurality of dimples 390 have generally a constant thickness, protrude on the cooling medium flow room 550 side and are indented on the anode side porous element 840 side. That is, the dimples 390 are convex when viewed from the cooling medium flow room 550 side and are concave when viewed from the anode side porous element 840 side. The plurality of dimples 390 are arranged systematically in a checkerboard pattern so as to be distributed completely around the cooling medium flow room 550 of the intermediary plate 500e during assembly. Thus, during assembly, the dimples 390 are located in the cooling medium flow room 550 of the intermediary plate 500 and are systematically arranged throughout the cooling medium flow room 550 in its entirety. In the example shown in FIG. 11A, they are disposed equidistantly in the lateral and vertical directions in FIG. 11A. The dimples 390 are formed by pressing a plate member so that it protrudes or becomes indented from the side in contact with the power generation section 800 toward the intermediary plate 500e side, forming dimples.

As illustrated in FIG. 10, the plurality of dimples 390 protrude from the other portions of the anode plate 300e to the intermediary plate 500e side to an extent greater than the thickness of the intermediary plate 500e (T+a). Thus, when assembled, the dimples 390 and cathode plate 400e will come into reliable contact with the apex P of the dimples 390. For example, the apex of the dimples 390 may become squeezed somewhat when assembled, so that the contact area may be ensured. Alternatively, the cathode plate 400e may be made of a highly elastic material, and the contact between the dimples 390 and cathode plate 400e may be strengthened by the repulsion force of the dimples 390.

In this embodiment, the anode side porous element 840 and cathode side porous element 860 function as reaction gas channels in the same manner as in the first embodiment. The anode side porous element 840 is preferably strong enough to result in a generally constant thickness relative to tightening stress in the stacking direction of the fuel cell stack. That is, the anode side porous element 840 is preferably deformed by the tightening stress in the stacking direction so as not to be taken into the indentations of the dimples 390. Thus, variation in the porosity of the anode side porous element 840 depending on the presence or absence of dimples 390 may be prevented. The surface pressure imposed on the anode side diffusion layer 824 may also be kept generally uniform. As a result, local deformation of the anode side diffusion layer 824 may be prevented, improving the drainage of the anode side diffusion layer 824. Furthermore, as will be described below, when dimples are formed on the cathode plate 400e, the cathode side porous element 860 preferably will have the same strength as the anode side porous element 840.

The cooling medium flowing from the cooling medium supply channel 534 into the cooling medium flow room 550 is diffused in the planar direction of the separator 1000 by the dimples 390 and distributed throughout the cooling medium flow room 550 in its entirety. The distributed cooling medium is discharged from the cooling medium exhaust channel 536 to the cooling medium exhaust manifold 160. Cooling medium flows through the space indicated by 301 in FIGS. 11B and 11C.

As described above, the separator 1000e in the third embodiment may provide both cooling performance and conductivity in the same manner as in the first and second embodiments.

In the third embodiment, the distributor structure for distributing the cooling medium is not separate but comprises the dimples 390 of the anode plate 300e, allowing the separator volume to be reduced. As a result, the fuel cell heat capacity may be reduced, improving fuel cell start-up at lower temperatures.

In the third embodiment, the dimples 390 also have a round shape, as viewed from the normal line of the anode plate 300e. A round shape tends to disperse stress in the normal line direction of the anode plate 300e, that is, in the stacking direction of the fuel cell. As a result, more uniform surface pressure may be exerted on the membrane electrode assembly 820 due to tightening force on the fuel cell in the stacked direction.

The number of parts may also be prevented from increasing because there is no need for a separate distributor in the separator 1000e of the third embodiment.

Dimples 390 are also provided in the anode plate 300e, and the power generation area DA of the cathode plate 400e is flat. Thus, as indicated by 301 in FIGS. 11B and 11C, the space through which the cooling medium flows is greater than the volume of the portion near the cathode side porous element 860. As a result, the cathode side porous element 860, where more heat is generated, may be efficiently cooled in the same manner as in Variation 2 of the first embodiment.

Because the flat cathode plate 400e results in uniform contact pressure on the cathode side porous element 860, a more consistent electrical reaction will take place on the cathode side porous element 860 side. Because of the slow rate of oxygen molecule diffusion, the electrochemical reaction in the fuel cell will generally be rate-limited by a 3-phase interfacial reaction (2H⁺+2e⁻+(½)O₂→H₂O) on the cathode side. Thus, with an emphasis on the electrochemical reaction on the cathode side porous element 860 side, dimples 390 are provided in the anode plate 300.

### Variations of Third Embodiment

### Variation 1

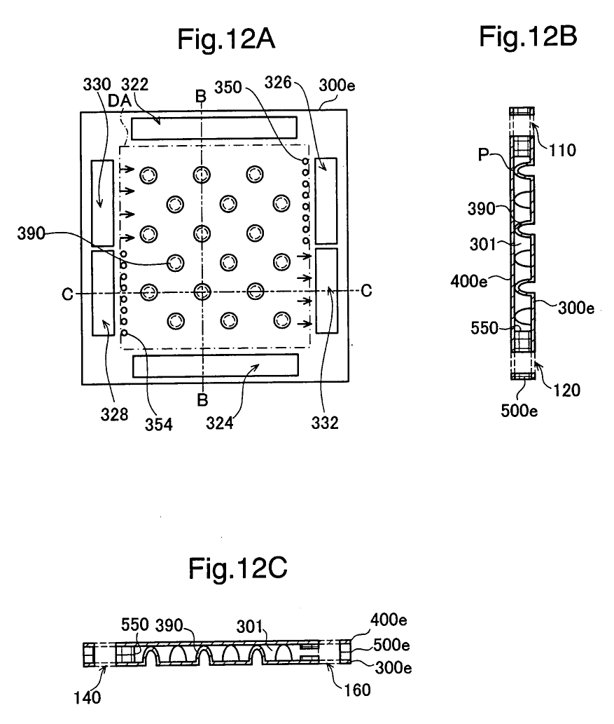

The separator in Variation 1 of the third embodiment will be described with reference to FIGS. 12A-C. FIGS. 12A-C illustrate the structure of the separator in Variation 1 of the third embodiment. FIG. 12A is an elevation of the separator. FIGS. 12B and 12C are cross sections of the separator corresponding to line B-B and line C-C, respectively, in FIG. 12A.

Variation 1 is different from the third embodiment in that the dimples 390 are arranged in a staggered pattern. In this way, the dimples 390 may be arranged in various locations. For example, when the number of dimples 390 per unit area is equal, the dimples may be arranged in a checkerboard pattern as in the third embodiment to reduce cooling medium pressure loss, and the dimples 390 may be arranged in a staggered pattern as in Variation 1 to increase cooling medium diffusion. Greater cooling medium diffusion will result in better fuel cell cooling efficiency.

### Variation 2

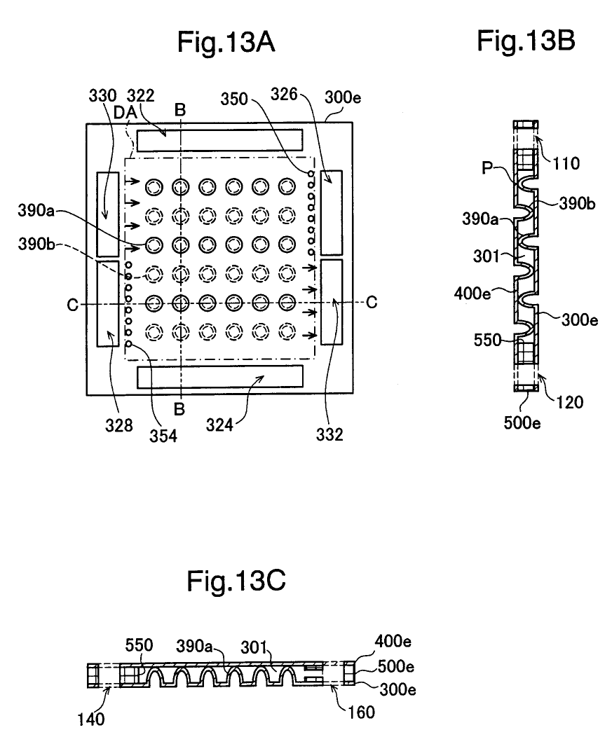

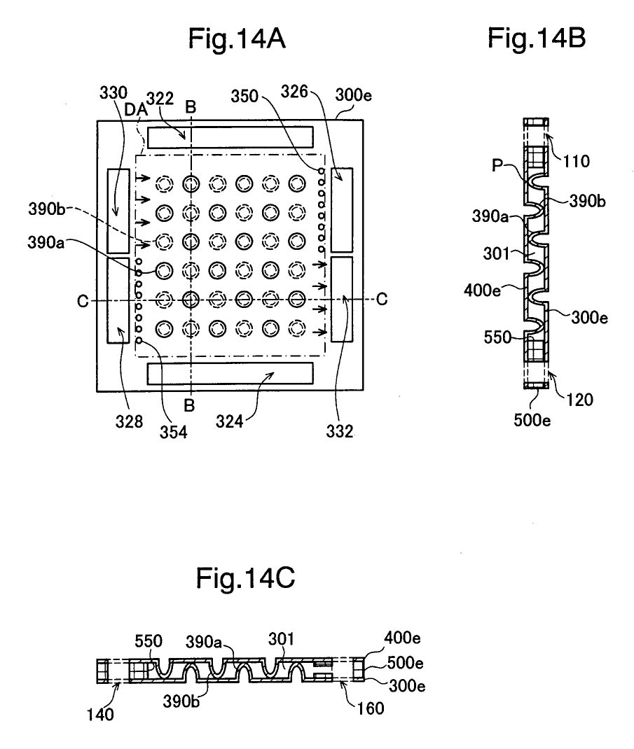

The separator in Variation 2 of the third embodiment will be described with reference to FIGS. 13A-C and 14A-C. FIGS. 13A-C illustrate the structure of an example of the separator in Variation 2 of the third embodiment. FIGS. 14A-C illustrate the structure of another example of the separator in Variation 2 of the third embodiment. FIGS. 13A and 14A are elevations of the separators. FIGS. 13B and 14A are cross sections of the separators corresponding to line B-B in FIGS. 13A and 14A, respectively. FIGS. 13C and 14C are cross sections of the separators corresponding to line C-C in FIGS. 13A and 14A, respectively.

Variation 2 is different from the third embodiment in that some dimples are formed on the cathode plate 400e. In FIGS. 13A and B and 14A through C, the dimples 390a indicate dimples formed on the anode plate 300e, and the dimples 390b indicate dimples formed on the cathode plate 400e. In this way, some or all of the dimples may be formed on the cathode plate 400e. As may be understood from the preceding description, the anode plate 300e and cathode plate 400e are plate-shaped members that have a generally constant thickness, and are convex on one side but concave on the other side, or concave on one side and convex on the other. These plate-shaped members may be produced, for example, when generally plate-shaped metal such as stainless steel or titanium is press molded in a pressing mold. The plate-shaped members may also be produced when conductive particles of carbon or the like are mixed with a binder such as resin, and the resulting conductive material is press molded in a press mold.

In the example illustrated in FIGS. 13A-C, dimples 390a are arranged at narrow intervals in a first direction (lateral direction in FIG. 13A) on the anode plate 300e, and dimples 390a are arranged at relatively wider intervals in a second direction (vertical direction in FIG. 13A) perpendicular to the first direction. Similarly, on the cathode plate 400e, dimples 390b are arranged at narrow intervals in a first direction (lateral direction in FIG. 13A), and dimples 390b are arranged at relatively wider intervals in a second direction (vertical direction in FIG. 13A) perpendicular to the first direction. When stacked as a separator, the rows of dimples 390a formed on the anode plate 300e and the rows of 390b formed on the cathode plate 400e are alternate in the second direction in the cooling medium flow room 550.

In the other example illustrated in FIGS. 14A-C, on the other hand, the dimples 390a are arranged in a zigzag pattern on the anode plate 300e. Dimples 390b are similarly arranged in a zigzag pattern on the cathode plate 300e. When stacked as a separator, the dimples 390a formed on the anode plate 300e and the dimples 390b formed on the cathode plate 400e are alternate in the first direction (lateral direction in FIG. 14A) and second direction (vertical direction in FIG. 14A) in the cooling medium flow room 550. The dimples 390a formed on the anode plate 300e and the dimples 390b formed on the cathode plate 400e are arranged in a checkerboard pattern as a whole in the cooling medium flow room 550. When arranged in this manner, portions of one plate that are in contact with the dimples of the other plate are dispersed throughout the plates as a whole. Stress may thus be prevented from becoming locally concentrated in the anode plate 300e and cathode plate 400e. The required thickness may thus be reduced in order to ensure the strength of the anode plate 300e and cathode plate 400e.

In Variation 2, the total indentation volume of the dimples 390b on the cathode plate 400e may be lower than the total indentation volume of the dimples 390a of the anode plate 300e. This will reduce the indentation volume of the dimples 390b where the water produced by the cathode is retained, thereby preventing the stagnant condition of the produced water and improving the drainage of the produced water.

The total indentation volume of the dimples 390b of the cathode plate 400e may contrarily be greater than the total indentation volume of the dimples 390a of the anode plate 300e. this will increase the indentation volume of the dimples 390b where water produced by the cathode is retained, thereby preventing the fuel cell from drying out.

The total indentation volume of the dimples 390a and 390b may be varied by varying the size of a dimple indentation or by varying the number of dimples.

### Variation 3

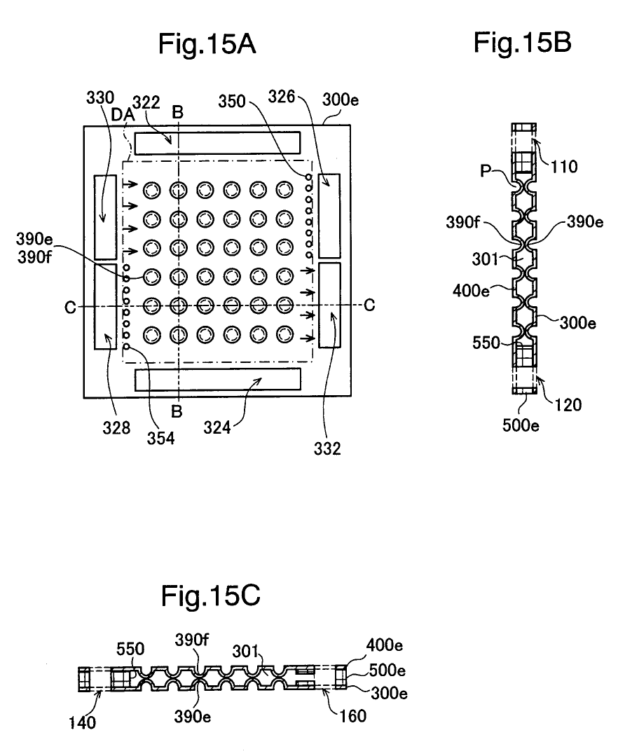

A separator in Variation 3 of the third embodiment will be described with reference to FIGS. 15A-C. FIGS. 15A-C illustrate the structure of the separator in Variation 3 of the third embodiment. FIG. 15A is an elevation of the separator. FIGS. 15B and 15C are cross sections of the separator corresponding to lines B-B and C-C in FIG. 15A.

Variation 3 differs from the third embodiment in that the dimples 390e formed on the anode plate 300e and the dimples 390f formed on the cathode plate 400e are arranged in overlapping locations in the fuel cell stacking direction (thicknesswise direction of the separator). When stacked as a separator, the protruding ends of the dimples 390e formed on the anode plate 300e and the protruding ends of the dimples formed on the cathode plate 400e are in contact with the cooling medium flow room 550.

The structure in Variation 3 may ensure the distribution of the cooling medium in the cooling medium flow room 550 and the conductivity in the thicknesswise direction of the separator in the same manner as the above embodiments and variations.

### Variation 4

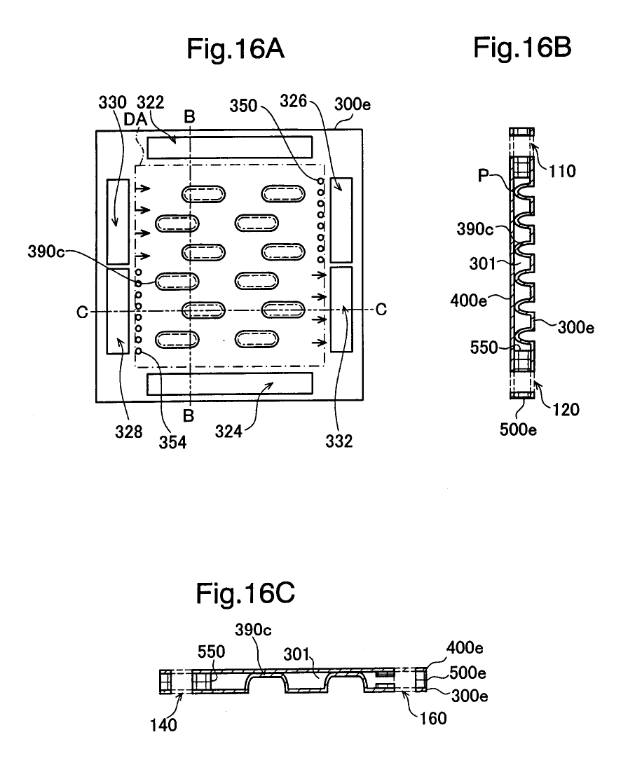

A separator in Variation 4 of the third embodiment will be described with reference to FIGS. 16A-C. FIGS. 16A-C illustrate the structure of the separator in Variation 4 of the third embodiment. FIG. 16A is an elevation of the separator. FIGS. 16B and 16C are cross sections of the separator corresponding to lines B-B and C-C in FIG. 16A.

Variation 4 differs from the third embodiment in that the shape of the dimples 390c formed on the anode plate 300e, as viewed from the normal line of the anode plate 300e, is not round, but is rib-shaped with a short side and a long side. It is thus possible to prevent the dimples from being broken by tightening force tightening the fuel cell in the stacked direction.

### Variation 5

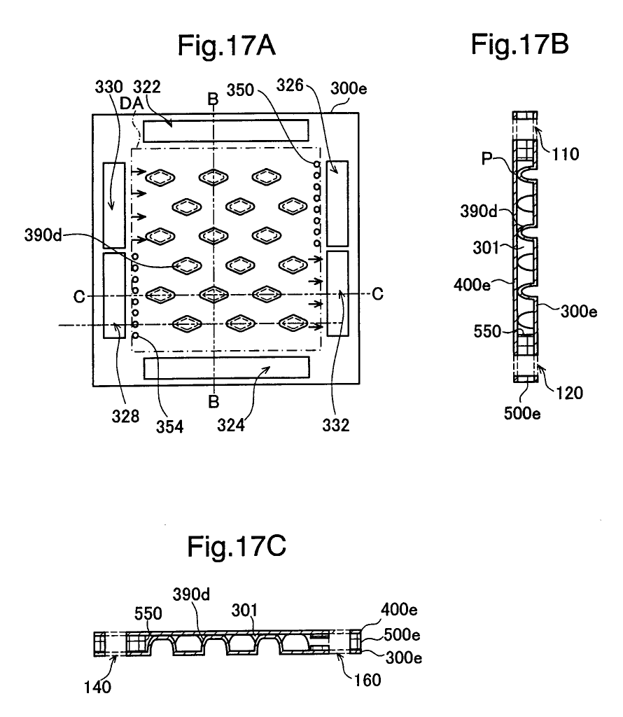

A separator in Variation 5 of the third embodiment will be described with reference to FIGS. 17A-C. FIGS. 17A-C illustrate the structure of the separator in Variation 5 of the third embodiment. FIG. 17A is an elevation of the separator. FIGS. 17B and 17C are cross sections of the separator corresponding to lines B-B and C-C in FIG. 17A.

Variation 5 differs from the third embodiment in that the shape of the dimples 390d formed on the anode plate 300e, as viewed from the normal line of the anode plate 300e, is not round, but is generally diamond-shaped. It is thus possible to prevent the dimples from being broken by tightening force tightening the fuel cell in the stacked direction. The shape of the dimples 390c is not limited to general diamond shapes but may also be generally polygonal, such as general parallelogram shapes, general square shapes, generally triangular shapes, generally pentagonal shapes, and generally hexagonal shapes. Generally speaking, the shape of the dimples 390d, as viewed from the normal line of the anode plate 300e, may have profiles with different curvatures. This will prevent the dimples from being broken by tightening force tightening the fuel cell in the stacked direction.

### D. Other Variations

In the above embodiments, stainless steel was used for the cathode plate 400, anode plate 300, and distributor 600, but other materials may also be used. Various gas-impermeable and conductive materials such as titanium and titanium alloys may be used for the cathode plate 400 and anode plate 300. Various conductive materials that are elastic to a certain extent, for example, metals such as titanium and titanium alloys, may be used for the distributor. The cathode plate 400, anode plate 300, and distributor 600 may also be surface treated (such as corrosion-resistant plating) to reduce contact resistance and improve corrosion resistance.

In the above embodiments, a heat-resistant resin allowing the bonding temperature to be lowered was used for the intermediary plate 500 in order to control thermal deformation, but a metal such as stainless steel or titanium may be used instead. A gasket employing an elastic part of rubber, an elastomer, or the like may also be used instead of the intermediary plate 500. Alternatively, instead of the intermediary plate 500, the outer periphery of the anode plate 300e and/or cathode plate 400e may be bent to the cooling medium flow room 550 side, and the anode plate 300e and cathode plate 400e may be brought into direct contact at the outer periphery and joined by welding, bonding, or the like. This will render the intermediary plate 500 unnecessary.

In the above embodiments, the contact between the distributor and the anode plate and cathode plate may undergo bonding treatment such as welding if needed. This may improve the strength or conductivity of the separator 1000.

The embodiments do not limit the types of arrangements that may be used to arrange the structures for distributing the cooling medium in the embodiments and Variations, such as the first plate-shaped members 610 and second plate-shaped members 620 in the distributor 600 of the first embodiment.

A reaction gas channel is preferably provided as a reaction gas channel on the plates (anode plate 300e and/or cathode plate 400e) equipped with dimples in the third embodiment and its Variations above. In the third embodiment and Variations 1, 4, and 5 of the third embodiment, for example, dimples are provided only on the anode plate 300e, and an anode side porous element 840 may therefore be provided at least as a fuel gas channel. In Variations 2 and 3 of the third embodiment, on the other hand, dimples are provided on both the anode plate 300e and cathode plate 400e, and an anode side porous element 840 and a cathode side porous element 860 may therefore both be provided as a fuel gas channel.

In the above embodiments and Variations, the surface of the anode plate opposite the anode and the surface of the cathode plate opposite the cathode may undergo hydrophilization treatment. This will prevent the water that is produced from being trapped near the electrodes and improve drainage. The hydrophilization treatment may involve the application of a hydrophilic agent such as titanium oxides, aluminum oxides, and silicon oxides.

Distributors with a variety of structures other than distributors 600 through 600d in the above embodiments and Variations may also be used. Specifically, the same action and effects as in the first embodiment may be obtained as long as the width in the stacked direction is greater then the thickness of the intermediary plate 500 and the material is elastic in the stacked direction, as in the distributor 600 of the first embodiment. The distributor is also preferably a shape that allows a plate to be readily produced by pressing without producing a load angle. For example, the above distributor 600 has plate-shaped members 610 and 620 on both sides of a substrate 650, but the structure may also have plate-shaped members on only one side. In such cases, the width of only the substrate and the plate-shaped members on the one side will be greater than the intermediary plate 500.

While the present invention have been shown and described on the basis of the embodiment and variations, the embodiment and variations described herein are merely intended to facilitate understanding of the invention, and implies no limitation thereof. Various modifications and improvements of the invention are possible without departing from the spirit and scope thereof as recited in the appended claims, and these will naturally be included as equivalents in the invention.

Furthermore, conventional intermediary plates are punched to form cooling medium channels to distribute the cooling medium, resulting in the problems of less freedom to arrange the cooling medium channels and inefficient distribution of the cooling medium.

The following aspects may be employed to overcome such problems.

### Other Aspect

A separator which is alternately stacked with a membrane electrode assembly to form a fuel cell, comprising:

a cathode plate disposed on the cathode side of a membrane electrode assembly;

an anode plate disposed on the anode side of a membrane electrode assembly;

an intermediary plate sandwiched between the cathode plate and anode plate, having a cooling medium flow through at least the area atop the membrane electrode assembly, as viewed in the stacked direction, where the cooling medium flows; and

a distributor that is disposed in the cooling medium flow portion and is formed by means of a non-porous element separate from the intermediary plate, the distributor being for distributing the cooling medium in the planar direction of the separator in the cooling medium flow portion.

The separator pertaining to this aspect has a cooling medium flow room between two plates sandwiching the intermediary plate. The distributor formed by means of a non-porous element separate from the intermediary plate is disposed in the cooling medium flow room, so that the cooling medium is distributed in the planar direction of the separator in the cooling medium flow room. As a result, there is greater freedom in arranging the distribution structure, and the fuel cell is cooled more efficiently, than when the cooling medium is distributed by a cooling medium channel provided in the intermediary plate through a punching process.

The separator pertaining to the other aspect may also be equipped with a cooling medium supply manifold passing through the separator in the thicknesswise direction, a cooling medium exhaust manifold passing through the separator in the thicknesswise direction, a cooling medium supply channel communicating with the cooling medium supply manifold and cooling medium flow room, and a cooling medium exhaust channel communicating with the cooling medium exhaust manifold and cooling medium flow room. This will allow the cooling medium flowing through the cooling medium flow room to be supplied to and discharged through the cooling medium supply/exhaust manifolds.

In the separator pertaining to the other aspect, the width of the distributor in the stacked direction may be greater than the thickness of the intermediary plate. This will ensure contact between the distributor and the cathode plate and between the distributor and the anode plate, and thus reduce contact resistance in the separator.

The distributor in the separator pertaining to the other aspect may be elastically deformable in the stacked direction. This will provide force to strengthen the contact between the distributor and the cathode plate and between the distributor and the anode plate, thus allowing contact resistance to be reduced in the separator.

In the separator pertaining to the other aspect, the distributor may have a substrate parallel to the intermediary plate and a plurality of elastic parts that are disposed on one or both sides of the substrate and are elastically deformed in the stacked direction. The elastic parts wills strengthen the contact between the distributor and the cathode plate and between the distributor and the anode plate, resulting in both better cooling medium distribution and lower contact resistance in the separator.

In the separator pertaining to the other aspect, the plurality of elastic parts may be disposed for distribution throughout the cooling medium flow room as a whole. The cooling medium will be distributed by the elastic members throughout the cooling medium flow room as a whole, allowing the fuel cell to be efficiently cooled.

In the separator pertaining to the other aspect 1, the elastic parts may be a plurality of first plate-shaped members that extend from the substrate at a certain angle and come into contact at their ends with the cathode plate, and a plurality of second plate-shaped members that extends from the substrate at a certain angle and come into contact at their ends with the anode plate. The first plate-shaped members and second plate-shaped members function as plate springs to produce force that strengthens the contact between the distributor and cathode plate and between the distributor and anode plate. The first plate-shaped members and second plate-shaped members also allow the cooling medium to be diffused inside the cooling medium flow room, thus improving the fuel cell cooling performance.

In the separator pertaining to the other aspect, the ends of the first plate-shaped members and second plate-shaped members may be bent parallel to the substrate, and the ends of the first plate-shaped members and second plate-shaped members may be bent perpendicular to the substrate. The shape of the ends in contact with the cathode plate and anode plate may be adjusted to adjust the magnitude of the pressure strengthening the contact between the distributor and cathode plate and between the distributor and anode plate.

In the separator pertaining to the other aspect, the gap between the substrate and the cathode plate may be greater than the gap between the substrate and the anode plate. This will make the flow in the cooling medium flow room greater on the cathode plate side than on the anode plate side, allowing the cathode plate side, where more heat is produced, to be efficiently cooled.

In the separator pertaining to the other aspect, the distributor may be a plate-shaped member having an undulating cross section, and the cooling medium flow room is divided into a plurality of cooling medium channels by the plate-shaped member having the undulating shape. This will allow the cooling medium to be efficiently distributed in the cooling medium flow room by the plurality of cooling medium channels formed in the cooling medium flow room.

In the separator pertaining to the other aspect, the cross section area of the cooling medium channels disposed on the cathode plate side among the plurality of cooling medium channels may be greater than the cross section area of the cooling medium channels on the anode plate side. This will make the flow in the cooling medium flow room greater on the cathode plate side than on the anode plate side, allowing the cathode plate side, where more heat is produced, to be efficiently cooled.

In the separator of the other embodiment, the distributor may be produced by plasticizing a plate member that is thinner than the intermediary plate. This will allow the distributor to be readily produced.

In the separator pertaining to the other aspect, the distributor may be a plurality of convex parts that have a convex shape and are disposed on the intermediary plate side of at least either the cathode plate or anode plate. The convex shaped parts will allow the cooling medium to be distributed in the cooling medium flow room.

In the separator pertaining to the other aspect, the plurality of convex parts may be disposed on the anode plate. This will make the flow in the cooling medium flow room greater on the cathode plate side than on the anode plate side, thus efficiently cooling the cathode plate side where more heat is produced.

In the separator of the other embodiment, the plurality of convex parts may be disposed so as to be distributed throughout the cooling medium flow room in its entirety. This will allow the cooling medium to be efficiently distributed throughout the cooling medium flow room as a whole.

In the separator of the other embodiment, the convex parts may be convex parts formed through the protrusion or indentation of the anode plate or cathode plate from the membrane electrode assembly toward the intermediary plate. This will allow anode or cathode plates with convex parts to be readily produced.

What is claimed is:

1. A fuel cell, comprising:
a porous element as a channel through which a reaction gas passes, the porous element having a first surface and a second surface;
a first electrode disposed at a side of the first surface of the porous element; and
a separator in contact with the second surface of the porous element, the separator including a first plate and a second plate, the first plate having a contact part in contact with the second surface, the second plate facing the first plate, wherein
a cooling medium channel is formed between the first plate and the second plate, and
the first plate has first dimples that are indented on a side of the porous element and protrude on a side of the cooling medium channel.

2. A fuel cell according to claim 1, wherein
the first dimples of the first plate are in contact with the second plate.

3. A fuel cell according to claim 1, wherein
the first electrode is an anode.

4. A fuel cell according to claim 1, wherein
the first electrode is a cathode.

5. A fuel cell according to claim 1, wherein
the second plate has second dimples that are indented on a side opposite the cooling medium channel and protrude on a side of the cooling medium channel.

6. A fuel cell according to claim 5, wherein
the second dimples of the second plate are in contact with the first plate.

7. A fuel cell according to claim 5, wherein
the second plate faces the second electrode on a side opposite the first plate.

8. A fuel cell according to claim 7, wherein
the first electrode is a cathode,
the second electrode is an anode, and
a total indented volume of the first dimples is lower than a total indented volume of the second dimples.

9. A fuel cell according to claim 7, wherein
the first electrode is a cathode,
the second electrode is an anode, and
a total indented volume of the second dimples is lower than a total indented volume of the first dimples.

10. A fuel cell according to claim 1, wherein
at least some of the first dimples are generally staggered, as viewed from a normal line direction of the first plate.

11. A fuel cell according to claim 1, wherein
at least some of the first dimples are disposed in a generally checkerboard pattern, as viewed from a normal line direction of the first plate.

12. A fuel cell according to claim 2, wherein
at least some of the first dimples have a generally circular shape, as viewed from a normal line direction of the first plate.

13. A fuel cell according to claim 2, wherein
at least some of the first dimples have a generally polygonal shape, as viewed from a normal line direction of the first plate.

14. A fuel cell according to claim 2, wherein
at least some of the first dimples have a shape with a short side and a long side, as viewed from a normal line direction of the first plate.

15. A fuel cell according to claim 2, wherein
at least some of the first dimples have profiles with different curvatures, as viewed from a normal line direction of the first plate.

16. A fuel cell according to claim 1, wherein
the first plate has undergone hydrophilicization.

17. A fuel cell according to claim 5, wherein
at least some of the first dimples and at least some of the second dimples are generally staggered, as viewed from a normal line direction of the first plate.

18. A fuel cell according to claim 5, wherein
at least some of the first dimples and at least some of the second dimples are disposed in a generally checkerboard pattern, as viewed from a normal line direction of the first plate.

19. A fuel cell according to claim 6, wherein
at least some of the first dimples and at least some of the second dimples have a generally circular shape, as viewed from a normal line direction of the first plate.

20. A fuel cell according to claim 6, wherein
at least some of the first dimples and at least some of the second dimples have a generally polygonal shape, as viewed from a normal line direction of the first plate.

21. A fuel cell according to claim 6, wherein
at least some of the first dimples and at least some of the second dimples have a shape with a short side and a long side, as viewed from a normal line direction of the first plate.

22. A fuel cell according to claim 6, wherein
at least some of the first dimples and at least some of the second dimples have profiles with a different curvature, as viewed from a normal line direction of the first plate.

23. A fuel cell according to claim 5, wherein
the first plate and the second plate have undergone hydrophilicization.
